(19) United States
(12) Patent Application Publication
(10) Pub. No.: US 2003/0076961 A1
(43) Pub. Date: Apr. 24, 2003

(54) Method for issuing a certificate using biometric information in public key infrastructure-based authentication system

(76) Inventors: Hee Sun Kim, Daejeon (KR); Taesung Kim, Daejeon (KR); Jong-Hyuk Roh, Incheon (KR); Dae Seon Choi, Daejeon (KR); Young Seob Cho, Daejeon (KR); Sang Rae Cho, Daejeon (KR); Seung Hun Jin, Daejeon (KR)

Correspondence Address: JACOBSON HOLMAN PLLC, 400 SEVENTH STREET N.W., SUITE 600, WASHINGTON, DC, 20004, US

(21) Appl. No.: 10/082,110

(22) Filed: Feb. 26, 2002

(30) Foreign Application Priority Data
Oct. 18, 2001 (KR) 2001-64187

(51) Int. Cl. H04L 9/00

(52) U.S. Cl. 380/282; 713/170

(57) ABSTRACT

A method for issuing a certificate using biometric information in a public key infrastructure-based authentication system is provided. In the present invention, an authentication code used to protect a certificate issuance request message is assigned to a user by a certificate authority not at a registration step but at a certificate issuance request step where a user authentication is performed with user's biometric information. Therefore, there is no need for a user to remember and enter the complex authentication code to be issued the certificate, thereby simplifying certificate issuance procedures. Further, in the present invention, the authentication code is assigned to the user at the certificate issuance step only after a real-time authentication using the user's biometric information is performed. For this reason, even though a reference code of the user is revealed to a third party before the certificate issuance step, it can be prevented that the third party tries to be issued the certificate, thereby maintaining higher reliability when the certificate is issued.

### FIELD OF THE INVENTION

The present invention relates to a public key infrastructure (PKI)-based authentication system; and, more particularly, to a method for issuing a certificate in a PKI-based authentication system.

### BACKGROUND OF THE INVENTION

In general, a public key infrastructure (PKI) is a system that is capable of performing encryption transmissions/receptions of digital documents requiring Internet security using public and private keys between member users authenticated by an authentication system. In other words, the PKI is a system in which the users registered as members in the authentication system are issued with digital certificates from a corresponding certificate authority, which certify that the public key of a certificate is allowed to a certificate user. The PKI users can encrypt digital documents requiring the Internet security using each other's public key and transmit the digital documents by executing digital signatures using their private keys, thereby allowing the digital documents to be reliably transmitted/received between the member-registered users in the authentication system.

In the conventional authentication system, at a certificate issuance step, it is required to verify what an identity of a user is and whether or not the user is issued with a certificate in order to issue the user with a certificate. Further, in the conventional authentication system, the initial user who is not yet issued with the certificate, must perform a proof of possession of private key (POP) through which he/she can prove that a private key corresponding to a public key is in his/her possession in order to be issued with a certificate of the public key which he/she generates by generating a public key pair of his/her private and public keys. For this, it is required for the user first to visit a registration authority linked to the certificate authority to request a user registration. If, as a result of the user registration request, the user is assigned from the registration authority a reference number and authentication code which enable the user to access the authentication system, the user sends the assigned reference number and authentication code to the certificate authority through his/her user system to be issued with the certificate.

The authentication code needed for certificate issuance is determined to be a complicated value of a great number of bits. For this reason, the user may have difficulty becoming familiar with and using the assigned authentication code from the registration authority. And to prevent the reference number and authentication code to be stored and remembered by the registration authority, the registration authority conventionally sends them by E-mail or provides them in printed form to the user. However, these conventional methods have a high risk of exposure of the reference number and authentication code. If the reference number and authentication code is exposed to ill-intentioned others, they may maliciously utilize them by stealth. Further, in these conventional methods, there is a problem in terms of complexity of certificate issuance procedures due to an authentication code input for the certificate issuance.

The above-described certificate issuance method in the PKI-based authentication system may refer to, for example, Korean Application of Patent No. 1999-0051586, titled “Method for Generating Public Key Certificate for User in Certificate Authority System”, and “Digital Signature Authentication Technology Trends” described in Journal of Korean Institute of Communication Sciences, 17(10): 105-117(2000.10). The “Method for Generating Public Key Certificate for User in Certificate Authority System” discloses just a method for quickly generating a public key certificate for a user in an authentication authority. In the “Digital Signature Authentication Technology Trends”, there are disclosed just standards required for implementing the PKI and a conventional method for issuing a certificate using a certificate management protocol (CMP). As a result, there still exists an inconvenience in the certificate issuance procedures due to the complex authentication code use at the certificate issuance request, and a risk of authentication code exposure at the certificate issuance step.

### SUMMARY OF THE INVENTION

It is, therefore, an object of the present invention to provide a certificate issuance method in which a certificate can be issued through a user authentication using biometric information in a public key infrastructure-based authentication system, thereby allowing a user to request a certificate issuance with no need to input a complex authentication code and improving security in certificate issuance procedures.

In accordance with the preferred embodiment of the present invention, there is provided a method for issuing a certificate using biometric information in a public key infrastructure-based authentication system including a registration authority, a certificate authority and a user system, the method comprising the steps of: a) receiving a certificate issuance request message containing a user's reference number and biometric information sent from the user system under the condition that a user accesses the certificate authority using the user system via the Internet to request a certificate issuance; b) extracting the user's reference number and biometric information from the certificate issuance request message to authenticate the user in connection with the certificate issuance request; c) determining whether the biometric information is the same as user's biometric information stored in a database storage unit in such a way as to be matched with the reference number under the condition that the user is registered as a member in the authentication system; d) generating an authentication code of the user having requested the certificate issuance and providing the generated authentication code to the user system; and e) receiving a public key from the user system and issuing the certificate if the user system generates the public key.

### BRIEF DESCRIPTION OF THE DRAWINGS

The above and other objects and features of the present invention will become apparent from the following description of preferred embodiments given in conjunction with the accompanying drawings, in which:

FIG. 1 is a network construction diagram of a public key infrastructure-based authentication system in accordance with the present invention;

FIG. 2 is a schematic block diagram showing the construction of a user system in accordance with the present invention;

FIG. 3 is a schematic block diagram showing the construction of a certificate authority server in accordance with the present invention; and

FIG. 4 is a flow chart illustrating a procedure of performing a certificate issuance in the user system of FIG. 2 and the certificate authority server of FIG. 3 in accordance with the present invention.

### DETAILED DESCRIPTION OF THE PREFERRED EMBODIMENTS

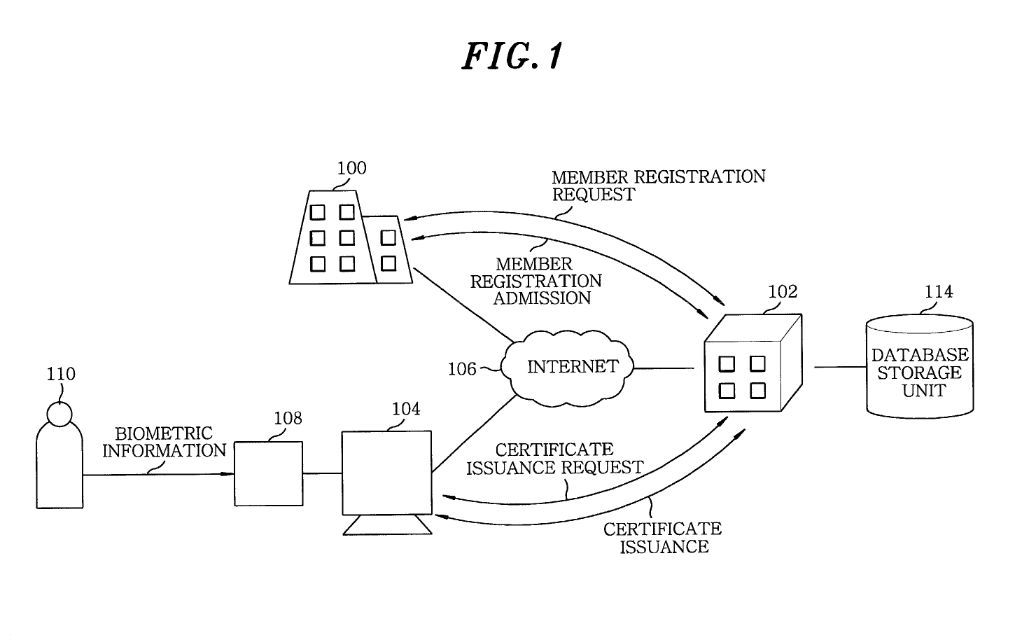

With reference to FIG. 1, there is shown in block form a network construction of a public key infrastructure-based authentication system in accordance with a preferred embodiment of the present invention. As shown in this drawing, the PKI-based authentication system includes a registration authority 100 for verifying identity of at least one user by proxy, a certificate authority 102 for generating a reference number and authentication code in response to a registration request from the user and issuing a certificate to the user, and a user system 104 for accessing the certificate authority 102 over the Internet and requesting the certificate authority 102 to issue a certificate of a user public key online.

The registration authority 100 exists between the certificate authority 102 and the user 110, physically being far away from the certificate authority 102. The registration authority 100 functions as a substitute for the certificate authority 102 to verify an identity and position of the user 110 in response to a certificate issuance request from the user 110. The registration authority 100 is connected to the certificate authority 102 through the Internet to transfer thereto the authentication system member registration request from the user 110. The registration authority 100 receives a result of the registration request from the certificate authority 102 and sends to the user 110 a reference number which enables the user 110 to be authenticated when the user 110 requests the certificate authority 102 to issue a certificate to him/her.

The user system 104 is a terminal device connectable to the Internet 106, such as a personal computer (PC). The user 110 accesses the certificate authority 102 through the user system 104 using the reference number sent from the registration authority 100 and his/her biometric information to request the issuance of the public key certificate.

Especially, in an embodiment of the present invention, it is possible to perform a user authentication only with the reference number and biometric information of the user in response to the certificate issuance request using the user system 104. Therefore, there is no need for the user to be fully aware of the complex authentication code which is conventionally required for the user to access the certificate authority 102 to be issued with the certificate. As a result, the present invention gives the user an advantage in that a member authentication procedure according to the certificate issuance request becomes simple. Further, the present invention is capable of allowing the certificate authority 102 to maintain a more reliable security service because of the user authentication using the user biometric information.

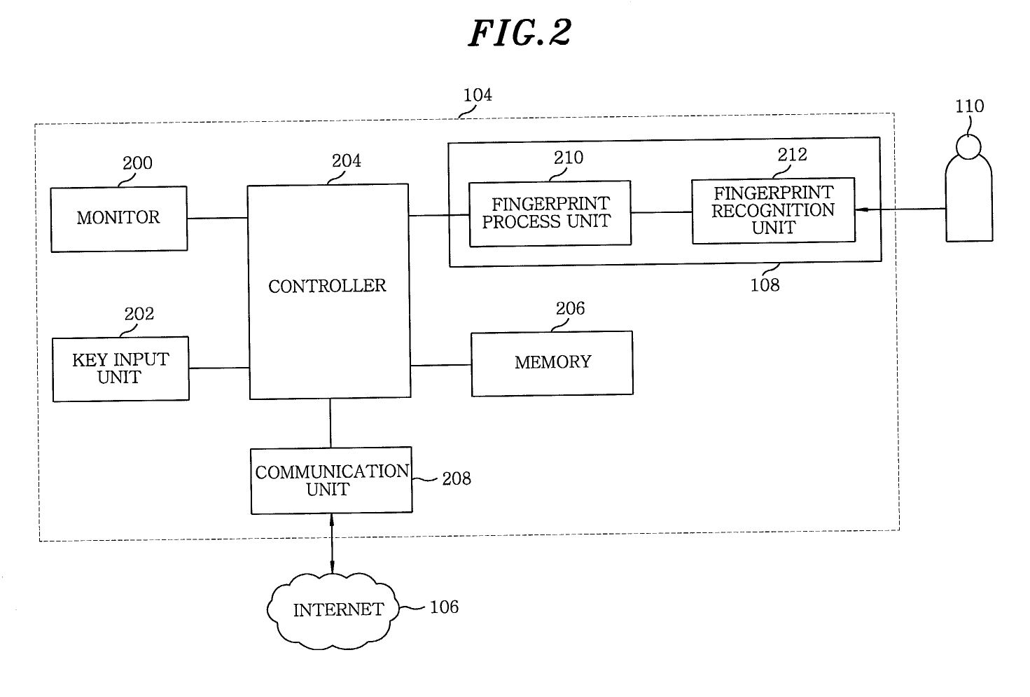

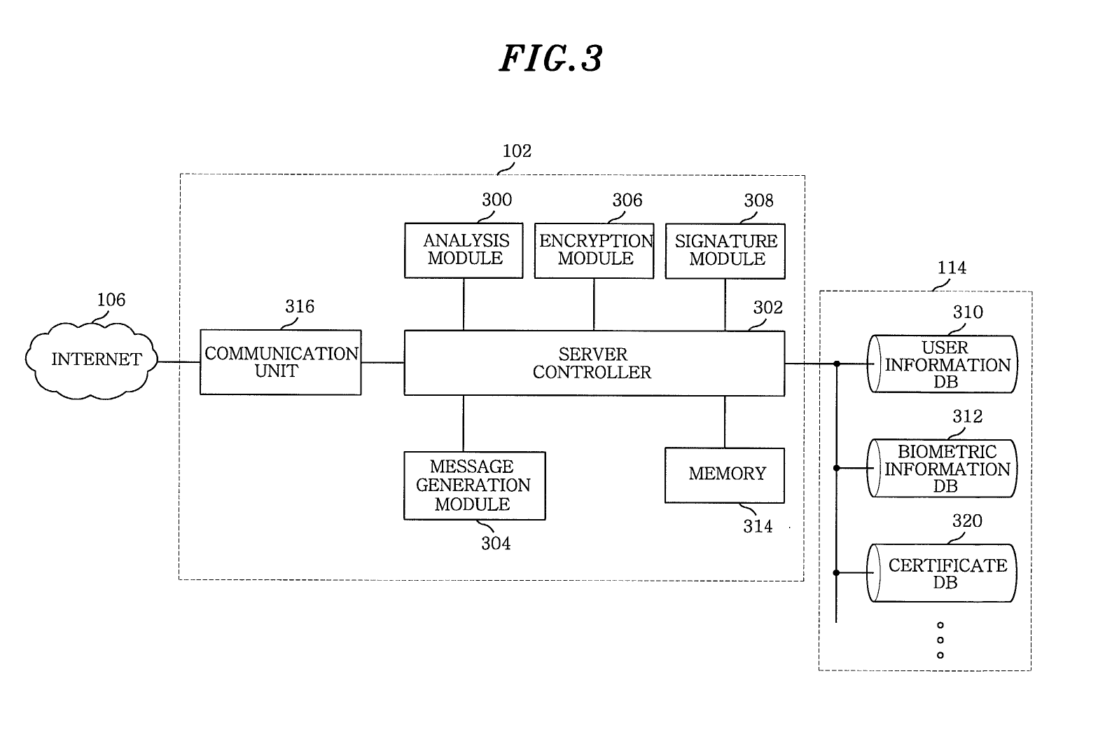

FIG. 2 is a schematic block diagram showing the construction of the user system 104 in FIG. 1. As shown in this drawing, the user system 104 includes a controller 204, a monitor 200, a memory 206, a communication unit 208, a key input unit 202 and a fingerprint information input unit 108. The controller 204 controls the entire operation of the user system 104. The controller 204 acts to download a Web page picture which is provided by the certificate authority 102 to the member user 110 of the authentication system when the user system 104 is connected to the authentication system according to the embodiment of the present invention, and to control the monitor 200 to display the downloaded Web page picture thereon. If there is a certificate issuance request from the user, the controller 204 acts to input the user biometric information entered from the user and send a unique user fingerprint information, or the biometric information, to the certificate authority 102 together with the certificate issuance request message, which unique user fingerprint information is inputted to the controller 204 through the fingerprint information input unit 108 which is a kind of a biometric information input unit.

The memory 206 stores a variety of operation programs required for the operation of the controller 204. The memory 206 has a read only memory (ROM) for storing basic data needed for driving the operation programs and a random access memory (RAM) for temporarily storing programs run according to the control of the controller 204 and data which are generated while the operation programs are operated. The communication unit 208 sends the certificate issuance message to the certificate authority 102 under the control of the controller 204 and interfaces data transmitted and received over the Internet 106 between the certificate authority 102 and the user system 104. The key input unit 202 which is a user interface has various numeral and function keys and acts to generate key event data corresponding to a key input from the user and to transfer the generated key event data to the controller 204. The monitor 200 is provided in the user system 104 to display a variety of operating states thereon under the control of the controller 204.

The fingerprint information input unit 108 has a fingerprint recognition unit 212 for scanning and inputting a fingerprint of the user through a fingerprint sensor and a fingerprint process unit 210 for analyzing the inputted unique user fingerprint information from the fingerprint recognition unit 212 to extract a unique fingerprint feature value of the user, and transferring the extracted feature value to the controller 204 of the user system 104. It should be noted that the fingerprint information input unit 108 is taken as an example of the biometric information input unit for the convenience of description in this embodiment of the present invention, and the unique user biometric information is not limited to the fingerprint information. In the present invention, various biometric information including, for example, iris information, a face feature vector and so forth can be used as the unique user biometric information.

The certificate authority 102 which is an essential object of the PKI-based authentication system is a system that performs the entire management of the validity of the certificate in response to registration, issuance and inquiry of the certificate. In the case of a digital document transmission/reception requiring security over the Internet, the certificate authority 102 which is a trusted third party issues a digital certificate for authenticating a user registered as a member in the authentication system to more reliably provide digital document transmission services using the certificate. If there is a certificate issuance request from the user system 104 in accordance with the embodiment of the present invention, the certificate authority 102 acts to authenticate the member user using the biometric information and generate an authentication code for the user. Then, the certificate authority 102 provides the generated authentication code to the user system 104. As a result, there is no need for the user to enter the authentication code to request the certificate issuance, thereby making the certificate issuance procedure simple.

FIG. 3 is a schematic block diagram showing the construction of the certificate authority server 102 in FIG. 1. Referring now to FIG. 3, a more detailed description will be given of the operation of the certificate authority server 102. The certificate authority server 102 includes an analysis module 300, a server controller 302, a message generation module 304, an encryption module 306, a signature module 308, a memory 314 and a communication unit 316. The certificate authority server 102 further has a connection to a database storage unit 114.

The analysis module 300 decrypts an authentication code request message or the certificate issuance request message, which both are encrypted and sent by the user system 104, under the control of the server controller 302 and checks confidentiality of the user biometric information.

Under the control of the server controller 302, the message generation module 304 generates an acknowledgment message for informing the user that a certificate has been normally issued in response to the certificate issuance request message, or an error message for informing the user that the certificate issuance procedure is in error due to non-matching of the biometric information. The signature module 308 executes a digital signature with respect to the issued certificate using a private key of the certificate authority 102. The encryption module 306 encrypts messages to be sent from the certificate authority server 102 to the registration authority 100 or the user system 104 with a public key of the registration authority 100 or the user system 104.

The server controller 302 controls the entire operation of the certificate authority server 102. Especially, when receiving the certificate issuance request message from the member user of the authentication system in accordance with the embodiment of the present invention, the server controller 302 checks the member user's biometric information from the user system 104 to perform an authentication with respect to the member user using the biometric information. If the member user who has requested the certificate issuance is determined to be a valid user, then the server controller 302 issues the certificate using the authenticate code for the user and controls the message generation module 304 to generate the acknowledgment message for informing the user that the certificate issuance request has been normally processed. Then, the server controller 302 controls the encryption module 306 and signature module 308 to protect the issued certificate such that the content thereof is not exposed and perform the digital signature with respect to the protect-processed certificate using the private key of the certificate authority 102. The server controller 302 sends the resulting certificate to the user system 104 online.

The database storage unit 114 which is referred to by the certificate authority server 102 includes various databases required for operating the certificate authority server 102, such as a user information database 310, biometric information database 312, certificate database 320, etc. The user information database 310 stores user information of the member-registered user and the reference number for the certificate issuance. The biometric information database 312 stores the biometric information of the member-registered user in such a way as to be matched with the user information. The certificate database 320 stores information about the certificate issued to the member user. The memory 314 stores a variety of operation programs required for the operation of the server controller 302. The memory 314 has a read only memory (ROM) for storing basic data needed for driving the operation programs and a random access memory (RAM) for temporarily storing programs run according to the control of the server controller 302 and data which are generated while the operation programs are operated.

The communication module 316 sends the acknowledgment message corresponding to the certificate issuance request and the issued certificate to the user system 104 under the control of the controller 302. The communication module 316 interfaces data transmitted and received between the user system 104 and the certificate authority server 102 over the Internet 106.

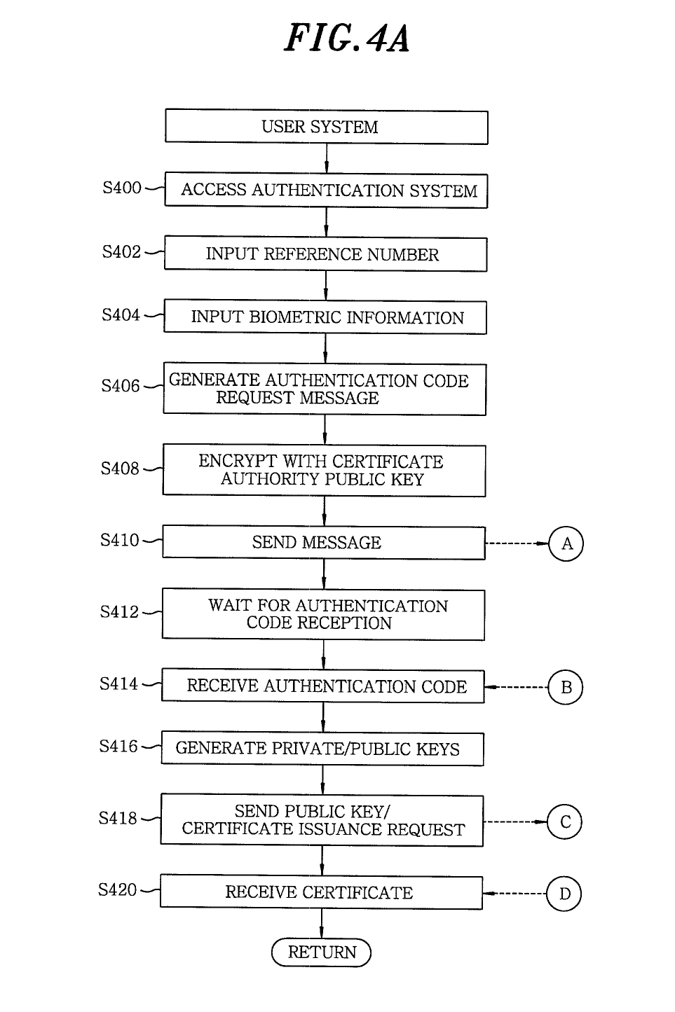

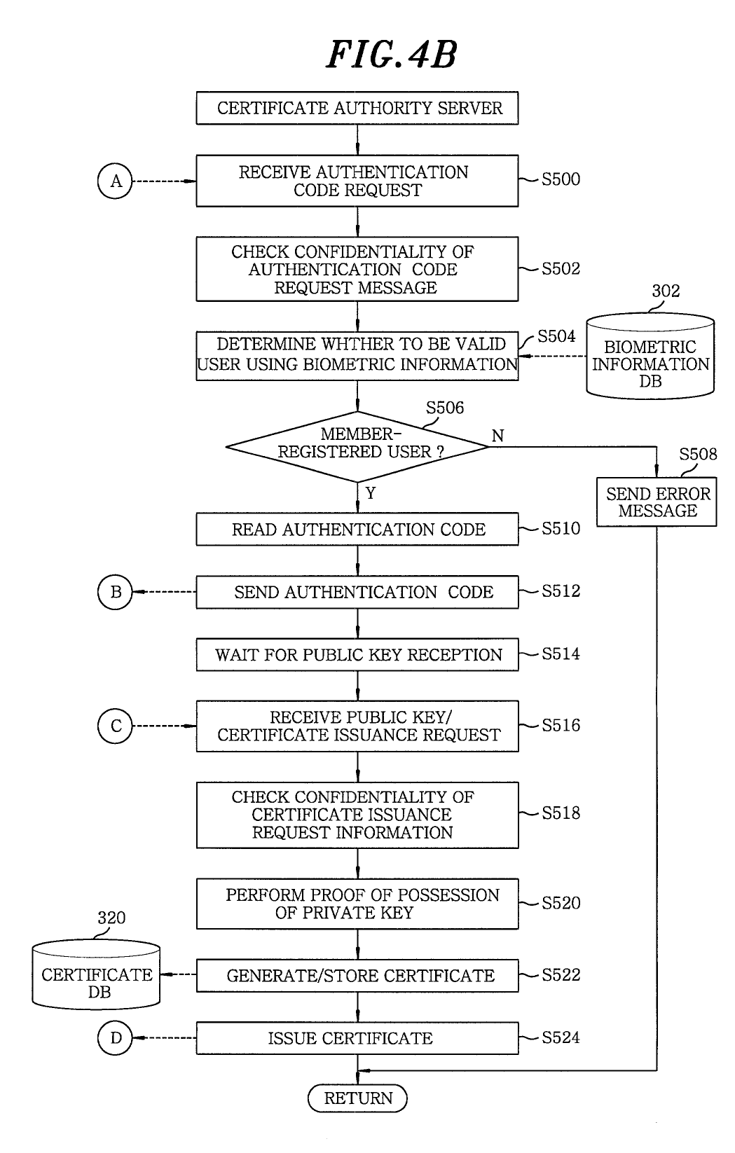

FIG. 4 is a flow chart illustrating a procedure of performing a certificate issuance in the user system 104 of FIG. 2 and the certificate authority 102 of FIG. 3 in accordance with the present invention. The certificate issuance procedure will be described in detail below with reference to FIGS. 1 to 4.

First, a user 110 gains access to the registration authority 100 to be registered in the authentication system. Then, the user 110 enters a variety of user identity information used to verify his or her identity and biometric information used in a certificate issuance according to the preferred embodiment of the present invention in order to request a member registration. The registration authority 100 functions as a substitute for the certificate authority 102 to verify identity of the user 110. The registration authority 100 sends user information, or the entered user identity information, and biometric information to the certificate authority 102 to request it for the user 110 to register the user 110 as a member. If there is a registration admission of the user 110 to the certificate authority 102, the certificate authority 102 generates a reference number in response to the registration admission. The registration authority 100 receives the generated reference number from the certificate authority 102 and provides it to the user 110. The reference number may be assigned to a user 110 that has requested a member registration in response to a member registration admission from the certificate authority 102. This reference number is used as reference information required for the user 110 to be authenticated as a member when the user 110 gains access to the certificate authority 102 through his/her user system 104 to request the certificate authority 102 to issue a certificate to him/her. Conventionally, the user 110 is assigned an authentication code as well as the reference code and must personally enter the authentication code to be authenticated as a member. However, as described above, it is troublesome for the user 110 to remember or to enter the authentication code personally because it is composed of very complicated codes for security. Further, the authentication code can be maliciously used by an ill-intentioned person. In this regard, in the preferred embodiment of the present invention, the registration authority 100 issues only the reference number to the user 110. In the preferred embodiment of the present invention, the authentication code is generated by the certificate authority 102 and provided to the user 110 when the user 110 accesses the authentication system to be authenticated as a member using the biometric information.

The user 110 that has requested the authentication system gains access to the authentication system through his/her user system 104 and performs a procedure of being issued the certificate from the certificate authority 102 in order to generate a private key and public key for providing secure services such as Internet banking, secure Web mail and so forth.

A detailed description will hereinafter be given of the procedure of being issued the certificate online through the user system 104.

The user 110 gains access to the certificate authority 102 using the user system 104 over the Internet 106 and enters the reference number issued from the registration authority 100 and the user's biometric information to be authenticated as a member. If there is a certificate authority access request from the user 110, at step 400, the user system 104 is connected to the certificate authority server 102 in response to the user's access request and displays a Web page of the certificate authority 102 for a certificate issuance on the monitor 200.

Accordingly, the user 110 enters the reference number issued from the registration authority 100 and the biometric information on the Web page to be authenticated as a member. The user system 104 inputs the reference number of the user 110 through the key input unit 202 at step 402, and fingerprint information, which is one of user's unique biometric information, through the fingerprint information input unit 108 at step 404. Subsequently, the user system generates an authentication code request message at step 406 and encrypts the generated request message with a public key of the certificate authority 102 at step 408. At step 410, the user system sends to the certificate authority server 102 the encrypted authentication code request message containing the reference number and biometric information, or the user's fingerprint information. After this, the user system 104 waits for the authentication code used in a certificate issuance request to be received from the certificate authority server 102 at step 412.

At step 500, the certificate authority 102 receives the authentication code request message from the user system 104 and at step 502, controls the analysis module 300 to decrypt the received request message, which is encrypted and sent from the user system 104, in order to check confidentiality of authentication code request information. Subsequently, the certificate authority 102 analyzes the reference number and biometric information contained in the authentication code request message, and determines whether the received biometric information is the same as biometric information stored in the biometric information database 312 in such a way as to be matched with the received reference number in order to determine whether the user accessing it is a valid one.

If it is determined at step 506 that the biometric information entered from the user 110 is not the same as the biometric information stored in the biometric information database 312 in such a way as to be matched with the reference number, the certificate authority server 102 proceeds to step 508 to control the message generation module 304 to generate an authentication code request error message for informing the user 110 that the authentication code request has not been normally processed and send the generated error message to the user system 104. Alternatively, if it is determined at step 506 that the biometric information entered from the user 110 is the same as the biometric information, which is stored in the biometric information database 312 in such a way as to be matched with the reference number, the certificate authority server 102 proceeds to step 510 to read out the authentication code which is generated together with the reference number and stored in the user information database 310. Then, the certificate authority 102 sends the read out authentication code to the user system 104 at step 512. After this, the certificate authority 102 waits for a public key used in a certificate issuance to be received from a user at step 514.

On the other hand, the user system 104 receives the authentication code from the certificate authority 102 at step 414 and generates user's private and public keys used in secure services which are provided via the authentication system at step 416. At step 418, the user system 104 generates a message for requesting the certificate issuance, protects the generated certificate issuance request message with the received authentication code, and sends the protected request message to the certificate authority server 102 together with information of the generated public key.

Subsequently, the certificate authority server 102 receives the certificate issuance request message from the user system 104 at step 516. Then, the certificate authority 102 controls the analysis module 300 to encrypt the received certificate issuance request message and check confidentiality of certificate issuance request information at step 518. At step 520, the certificate authority 102 performs a proof of possession of private key (POP) with respect to the private key received from the user system 104 to check whether the user possesses a private key corresponding to the public key. Thereafter, the certificate authority server 102 generates the certificate and stores the generated certificate in the certificate database 320 at step 522. At step 524, the certificate authority 102 controls the encryption module 306 and signature module 308 to protect with the authentication code the generated certificate issued to the user and an acknowledgment message notifying the user that the certificate issuance has been normally processed. Further, at step 524, the certificate authority 102 executes a digital signature with respect to the generated certificate and the resulting certificate to the user system 104. At step 420, the user system 104 receives the certificate from the certificate authority 102 and displays the received certificate for the user 110 such that he/she knows that the certificate issuance has been normally processed. As a result, the user 110 can become aware of the certificate issuance and can utilize a variety of secure services provided by the authentication system using the issued certificate.

As apparent from the above description, the present invention provides a method for issuing a certificate using biometric information in a PKI-based authentication system, in which an authentication code used to protect a certificate issuance request message is assigned to a user by a certificate authority not at a registration step but at a certificate issuance request step where a user authentication is performed with user's biometric information. Therefore, there is no need for a user to remember and enter the complex authentication code to be issued the certificate, thereby simplifying certificate issuance procedures. Further, in the present invention, the authentication code is assigned to the user 110 at the certificate issuance step only after a real-time authentication using the user's biometric information is performed. For this reason, even though a reference code of the user 110 is revealed to a third party before the certificate issuance step, it can be prevented that the third party tries to be issued the certificate, thereby maintaining higher reliability when the certificate is issued.

While the invention has been shown and described with respect to the preferred embodiments, it will be understood by those skilled in the art that various changes and modifications may be made without departing from the spirit and scope of the invention as defined in the following claims.

What is claimed is:

1. A method for issuing a certificate using biometric information in a public key infrastructure-based authentication system including a registration authority, a certificate authority and a user system, the method comprising the steps of:
a) receiving a certificate issuance request message containing a user's reference number and biometric information sent from the user system under the condition that a user accesses the authentication system using the user system via the Internet to request a certificate issuance;
b) extracting the user's reference number and biometric information from the certificate issuance request message to authenticate the user in connection with the certificate issuance request;
c) determining whether the biometric information is the same as user's biometric information stored in a database storage unit in such a way as to be matched with the reference number under the condition that the user is registered as a member in the authentication system;
d) generating an authentication code of the user having requested the certificate issuance and providing the generated authentication code to the user system; and
e) receiving a public key from the user system and issuing the certificate if the user system generates the public key.

2. The method of claim 1, wherein the step d) includes the steps of:
d1) receiving the authentication code from the authentication system and generating a private key and a public key; and
d2) sending the generated public key to a server of the certificate authority to be issued the certificate.

3. The method of claim 1, wherein the step e) includes the steps of:
e1) if receiving the public key at the step e), determining using the public key whether the private key has been normally generated to form a key pair with the public key under the condition that the private key corresponding to the public key is generated; and
e2) issuing the certificate if the private key has been normally generated.

4. The method of claim 1, wherein the database storage unit includes:
a user information database for storing the reference number for the certificate issuance and user information under the condition that the user is registered as a member in the authentication system; and
a biometric information database for storing the biometric information of the user registered as the member, the user information and the biometric information being registered and stored in such a way as to be matched with each other.

5. The method of claim 1, wherein the user system includes a biometric information input unit for inputting the biometric information of the user.

6. The method of claim 1, wherein the biometric information is information about a user's unique fingerprint.

7. The method of claim 1, wherein the biometric information is information about a user's unique iris.

8. The method of claim 1, wherein the biometric information is information about a user's unique face feature vector.
